(19) United States
(12) Patent Application Publication
(10) Pub. No.: US 2012/0085850 A1
(43) Pub. Date: Apr. 12, 2012

(54) FOOD-GRATING SYSTEM

(76) Inventor: Joel TETREAULT, Roswell, GA (US)

(21) Appl. No.: 12/984,789

(22) Filed: Jan. 5, 2011

Related U.S. Application Data
(63) Continuation-in-part of application No. 29/376,554, filed on Oct. 8, 2010, now Pat. No. D642876.

(51) Int. Cl. B02C 19/00

(52) U.S. Cl. 241/101.2

(57) ABSTRACT

A food-grating system including a food container and a food grater. The food container includes a vessel and a lid, and the food grater includes a handle/frame assembly and a grater insert-panel. The handle/frame assembly of the grater mounts, by a coupling system including mating interlocking elements, to the vessel of the container for grating use. The lid of the container mounts, by a closure system including mating interlocking elements, to the vessel of the container for storage, whether or not the grater is also mounted to the vessel. And the grater insert-panel removably mounts, by a coupling system including mating interlocking elements, to the handle/frame assembly of the grater so that interchangeable insert-panels can be used for differing grating functions.

### CROSS-REFERENCE TO RELATED APPLICATION

This application is a continuation-in-part of U.S. Design patent application Ser. No. 29/376,554 filed November Oct. 8, 2010, the scope of which is hereby incorporated by reference.

### TECHNICAL FIELD

The present invention relates generally to food preparation implements and, in particular, to implements for grating cheese and/or other food items.

### BACKGROUND

Graters are commonly used in food preparation for grating cheese and other food items such as potatoes, eggs, vegetables (carrots, onions, etc.), citrus peels, and spices. Conventional hand graters typically include a handle for grasping and a grating panel with apertures formed in part by indentations. The exposed edges of the panel adjacent the apertures form blades that shave off small pieces of the food, and the small pieces fall through the apertures, thereby grating the food item.

When using conventional hand graters, some people hold the food item in one hand and the grater handle in the other hand, then slide the grater panel relative to the food item. This can be an unwieldy and awkward operation for many people, with the result that the hands can get scrapped and/or cut by the blade edges of the grater. To reduce these hazards, other times grating is done by pressing the distal end of the grater panel against a horizontal surface, such as a countertop or cutting board, while holding the grater at an angle to the surface, and scrapping the food item across the grater panel. But the grater panel can slip across the surface and the food item sometimes slips against the grater, which can cause frustration and still result in user injury. Also, the pressure applied tends to be uneven, resulting in non-uniformly grated food pieces.

In addition, conventional hand graters include only one grating panel with one size of grating apertures. So multiple different graters (often five or six) are typically needed for the various types of grating commonly done in many kitchens, thereby creating clutter in the storage drawer and requiring additional expenditures for them. Other conventional hand graters include a handle for grasping and a rectangular or trapezoidal frame with two or four grating panels with different-sized grating apertures. These box graters provide the benefit of a single implement that can be used to grater food into different sizes. But box graters are typically large and bulky and cannot be easily stored in many kitchen drawers.

Accordingly, it can be seen that needs exist for improved food graters. It is to the provision of solutions to these and other problems that the present invention is primarily directed.

### SUMMARY

Generally described, the present invention relates to a system for grating food. In an example embodiment, the food-grating system includes a food container and a food grater. The food container includes a vessel and a lid, and the food grater includes a handle/frame assembly and a grater insert-panel. The handle/frame assembly of the grater mounts, by a coupling system including mating interlocking elements, to the vessel of the container for grating use. In a typical commercial embodiment, the grater-vessel interlocking elements are provided by a tab-and-slot arrangement at the distal end and a deflectable-arm-and-opening arrangement at the proximal end. The lid of the container mounts, by a closure system including mating interlocking elements, to the vessel of the container for storage, whether or not the grater is also mounted to the vessel. In a typical commercial embodiment, the vessel-lid interlocking elements are provided by a flange extending outward from the upper vessel peripheral wall and a flange extending inward from the periphery of the lid with an interference fit. And the grater insert-panel removably mounts, by a coupling system including mating interlocking elements, to the handle/frame assembly of the grater so that interchangeable insert-panels can be used for differing grating functions. In a typical commercial embodiment, the panel-frame interlocking elements are provided by a tab-and-slot arrangement at the distal end and a deflectable-arm-and-opening arrangement at the proximal end.

In some embodiments, the grater includes a notch that catches on the vessel rim (the peripheral wall upper edge) to help hold the grater in place during grating use. In some embodiments, the vessel includes interior shelves upon which the grater rests when mounted to the vessel for stability. In some embodiments, the grater is provided with an integral grating panel, instead of with an interchangeable one. And in some embodiments, the grater frame/handle assembly it provided with multiple interchangeable grating panels, but without the container.

The specific techniques and structures employed to improve over the drawbacks of the prior devices and accomplish the advantages described herein will become apparent from the following detailed description of example embodiments and the appended drawings and claims.

### BRIEF DESCRIPTION OF THE DRAWINGS

FIG. 1 is a top perspective exploded view of a food-grating system according to a first example embodiment of the present invention, showing a food container with a bottom vessel and a top lid and a food grater with a handle/frame assembly and first grater insert-panel.

FIG. 2 is a bottom perspective exploded view of the food-grating system of FIG. 1.

FIG. 3 is a side cross-sectional view of the container of FIG. 1, showing the lid mounted to the vessel for food storage, without the grater.

FIG. 4 is a side cross-sectional detail view of a distal portion of the vessel and the lid of FIG. 3, showing the lid being mounted onto the vessel.

FIG. 5 side cross-sectional detail view of a distal portion of the vessel and the grater of FIG. 1, showing the grater positioned on the vessel for grating use.

FIG. 6 is a side cross-sectional view of the vessel and the grater of FIG. 1, showing the grater mounted to the vessel for grating use.

FIG. 7 shows a distal portion of the vessel and the grater of FIG. 6, with the grater being mounted onto the vessel.

FIG. 8 shows a distal portion of the vessel and the grater of FIG. 6, with the grater being mounted onto the vessel.

FIG. 9 shows the vessel and the grater portions of FIG. 8 mounted together.

FIG. 10 is a side cross-sectional view of the container and the grater of FIG. 1, showing the grater and the lid mounted to the vessel for system storage.

FIG. 11 is a top perspective view of the food grater of FIG. 1, showing the first grater insert-panel mounted to the handle/frame assembly.

FIG. 12 is a side cross-sectional detail view of a distal portion of the food grater taken at line 12-12 of FIG. 11.

FIG. 13 is a side cross-sectional detail view of a proximal portion of the food grater taken at line 13-13 of FIG. 11.

FIG. 14 is a top perspective view of the handle/frame assembly of FIG. 11, showing a second grater insert-panel mounted to the handle/frame assembly.

### DETAILED DESCRIPTION OF EXAMPLE EMBODIMENTS

Generally described, the present invention relates to a system for grating food. The food-grating system can be adapted for use in kitchens in homes, restaurants, or elsewhere, and for any of a variety of types of food items such as cheese, potatoes, eggs, vegetables (carrots, onions, etc.), citrus peels, and spices.

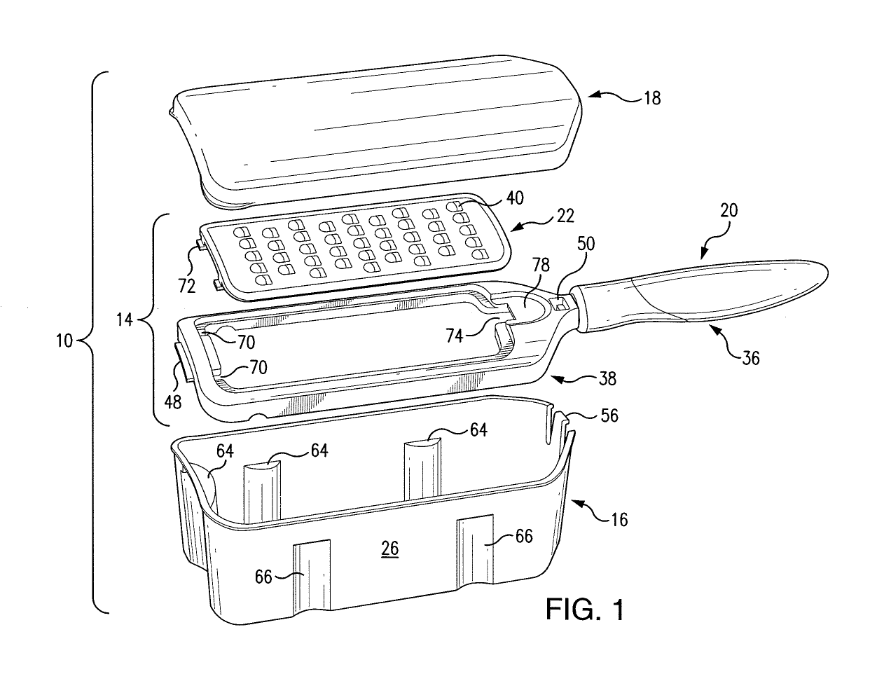

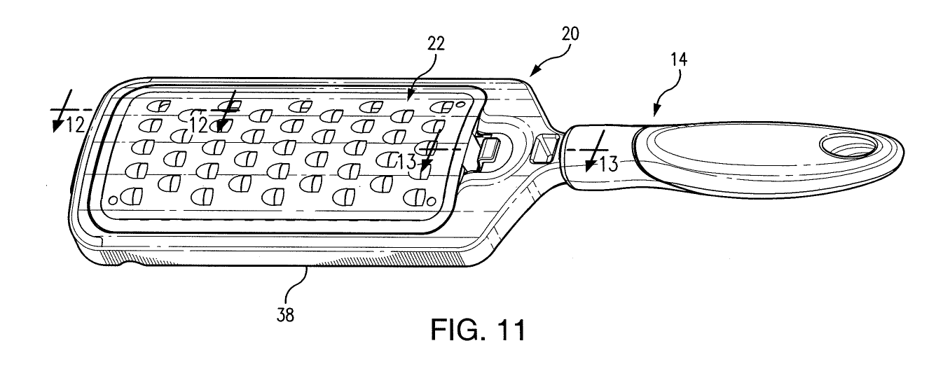

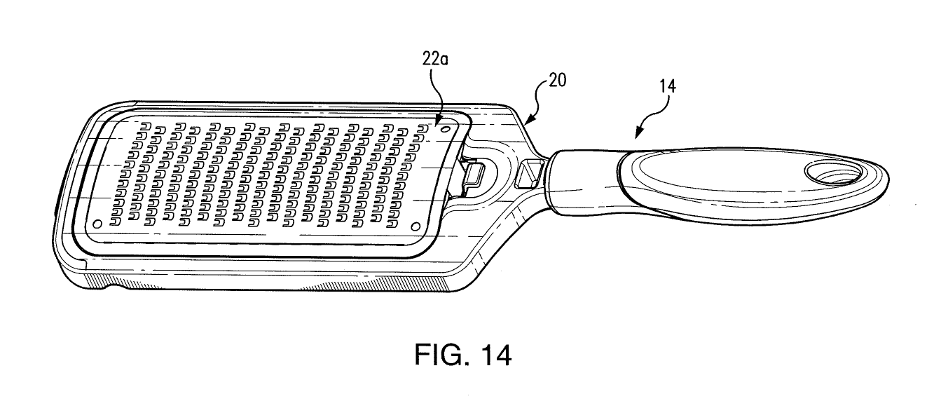

FIGS. 1-14 show a food-grating system 10 according to an example embodiment of the present invention. The food-grating system 10 includes a food container 12 and a food grater 14. The food container 12 includes a vessel 16 and a lid 18, and the food grater 14 includes a handle/frame assembly 20 and a grater insert-panel 22.

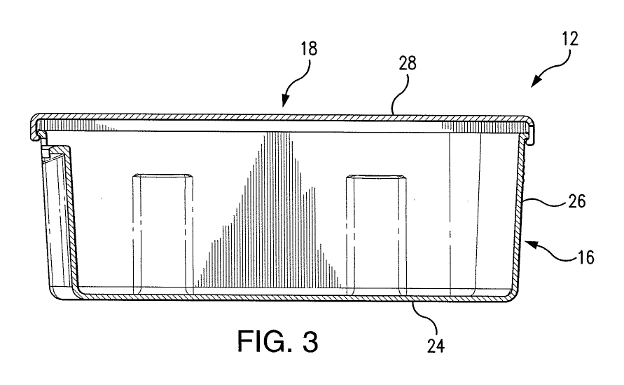

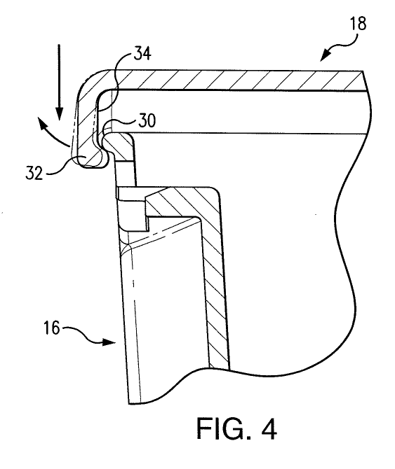

Referring with particularity to FIGS. 3-4, the food container 12 can be constructed of conventional materials such as hard plastic using conventional fabrication techniques such as molding, and includes some basic structural components of common kitchen food containers. In particular, the vessel 16 has a bottom wall 24 and a peripheral wall 26 extending upward from the bottom wall 24 so that the top is open and food items can be placed in the vessel for storage. And the lid 18 has a top wall 28 that covers the open top of the vessel 16, and it removably attaches to the peripheral wall 26 to close the container. In the depicted embodiment, for example, the bottom wall 24 and the top wall 28 are generally rectangular and the peripheral wall 26 includes four sides or panels. In other embodiments, the food container 12 has other regular or irregular shapes such as circular or polygonal.

The lid 18 is removably coupled to the vessel 16 by a closure system including mating interlocking elements on the upper portion of the vessel peripheral wall 26 and on the periphery of the lid top wall 28. In the depicted embodiment, for example, the vessel-lid interlocking element on the vessel 16 is a flange 30 extending outwardly from the upper portion of the vessel peripheral wall 26, and the one on the lid 18 is a flange 32 extending inwardly from the periphery of the lid top wall 28. FIG. 3 shows the flanges 30 and 32 interfering with each other to lock the lid 18 onto the vessel 16. The flange 32 on the lid 18 extends inwardly from a resiliently deflectable wall section 34, so that when the lid is moved (e.g., pressed) down onto (as indicated by the downward directional arrow in FIG. 4) or removed (e.g., pulled) up away from the vessel 16, ramped (e.g., curved or flat) surfaces of the flanges 30 and 32 cause the wall section 34 to resiliently deflect outward (as indicated by the angular directional arrow in FIG. 4) until the flanges have passed each other. The flanges 30 and 32 each can be provided by a continuous peripheral protrusion or lip, a series of bumps or other protrusions, or by other conventional flange-like structures.

In alternative embodiments, the mating interlocking elements on the vessel 16 and the lid 18 are provided by other closure systems that are adapted to permit the lid 18 to be removably coupled to the vessel 16, whether to provide an air-tight seal (for storing food in the container after the grating and food preparation/cooking process) or not (for using the container food storage only during the grating and food preparation/cooking process). Such alternative mating interlocking elements include other detent and snap-fit closure systems such as those that function similarly to that depicted. In some such alternative embodiments, the resiliently deflectable wall section is provided by the vessel peripheral wall instead of the lid, and in others there are resiliently deflectable wall sections on both the vessel peripheral wall and the lid.

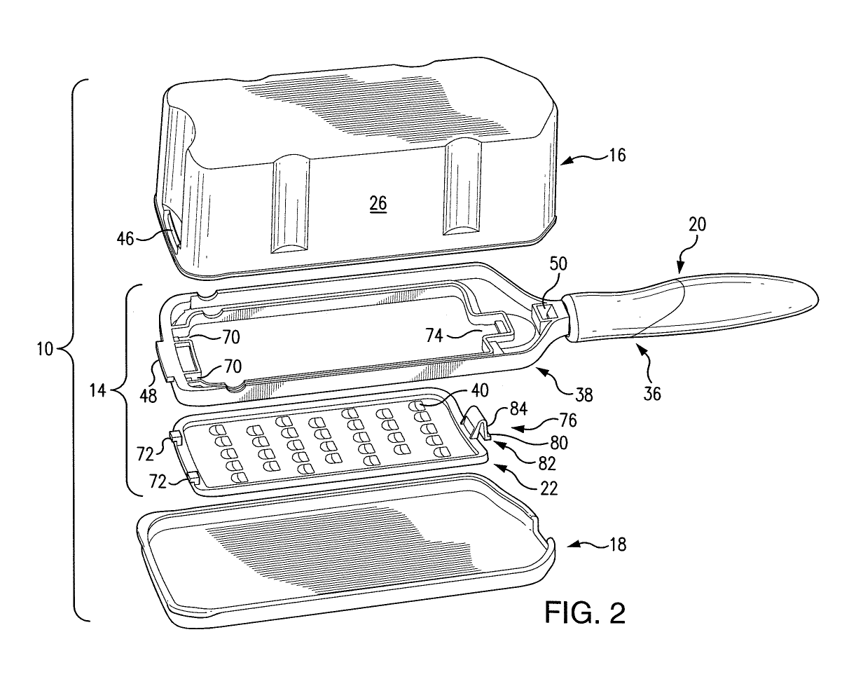

Referring back to FIGS. 1-2, the handle/frame assembly 20 of the food grater 14 includes a handle 36 and a peripheral frame 38 extending distally from the handle. The handle 36, the peripheral frame 38, and the grater insert-panel 22 can be constructed of conventional materials such as hard plastic or metal using conventional fabrication techniques such as molding, and include some basic structural components of common kitchen food graters. In particular, the handle 36 is adapted for grasping by a human hand for manual grating use. And the grater insert-panel 22 defines an array of apertures 40 formed in part by indentations, with the exposed edges of the panel adjacent the apertures forming blades that shave off small pieces of the food that then fall through the apertures.

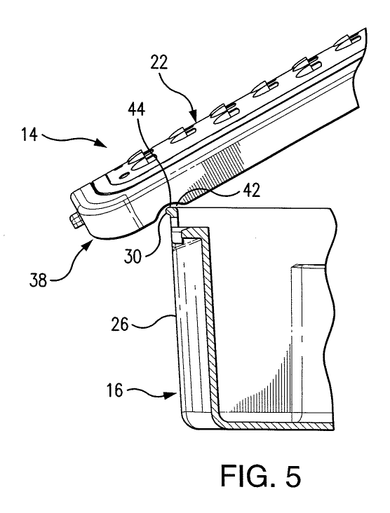

Referring additionally to FIG. 5, the frame 38 of the food grater 14 includes at least one notch 42 that can be received by a top end 44 (e.g., at least partially defining the flange 30) of the container vessel 16. The notch 42 can have a semi-circular profile, as depicted, or it can have another regular or irregular profile such as a non-symmetrical triangular shape with the proximal surface generally vertical (or at least more vertical than the distal surface) to better catch on the vessel top end 44. In embodiments in which the frame 38 extends sufficiently lower than the insert-panel 22 that the insert-panel does not contact the vessel top end 44, the notch 42 is formed by two aligned notches in the frame. In embodiments in which the frame 38 does not extend sufficiently lower than the insert-panel 22, the notch is formed by a single continuous channel across the frame and the insert-panel. In other embodiments the notch is formed between two protrusions extending downwardly from the frame 38. And in still other embodiment the notch is formed by wings extending laterally from the frame 38 that are engaged by the top edges of two opposing panels of the peripheral wall 26 of the vessel 16.

In use, the user can grasp the grater 14 by the handle 36, position the frame 38 so it rests atop the vessel 16 with the vessel top end 44 received in the notch 42, and slide a food item back and forth across the top surface of the grater panel-insert 22. The food item is thereby shaved into small pieces that fall through the apertures in the panel-insert 22 and into the container vessel 16 for containment. The notch 42 catches on the vessel top end 44 so that the grater 14 is better secured in place during grating use. In this way, the notch 42 provides for increased ease and safety of use.

It will be noted that the grater 14 with the notch 42 can be used with any kitchen structure having a generally vertical wall with an upper end, such as other food containers, plates, cutting boards, etc., as long as their top ends can be received in the notch 42 such that the notch is caught and the grater is generally held in place. Also, in other embodiments there are provided food graters with integral grater panels (instead of the replaceable panel-inserts 22) that include the notch 42.

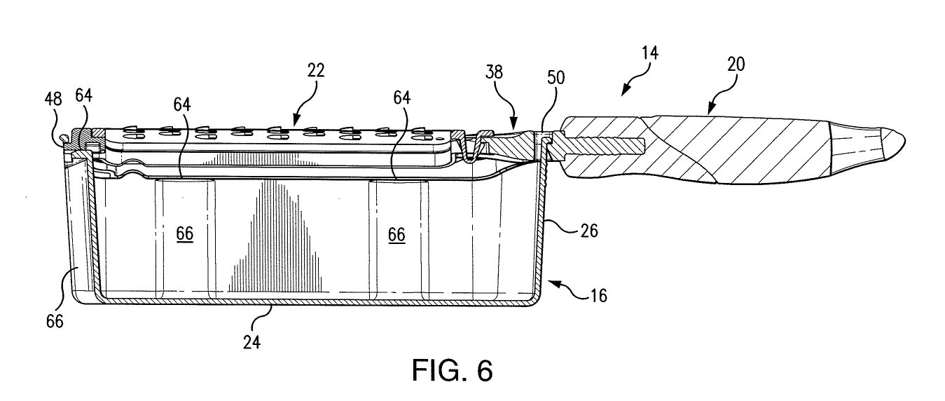

Referring additionally to FIGS. 6-10, the grater 14 alternatively can be secured to the container vessel 16 for use, in embodiments with and without the notch 42. The grater 14 is removably coupled to the container vessel 16 by a coupling system including mating interlocking elements on the upper portion of the vessel peripheral wall 26 and on the grater frame 38. In the depicted embodiment, for example, there are two sets of vessel-grater interlocking elements, one set each at the proximal and distal ends of the food-grating system 10. The distal vessel-grater interlocking element on the vessel 16 can be provided by at least one slot 46 defined by the vessel peripheral wall 26, and the one on the grater 14 can be provided by at least one tab 48 extending from the lid wall 28 and receivable in the slot, or vice versa. One slot 46 and tab 48 are depicted, though more sets of these can be suitably provided.

And the proximal vessel-grater interlocking element on the grater 14 can be provided by at least one opening 50 in the frame 38, and the one on the vessel 16 can be provided by at least one resiliently deflectable arm 54 formed by the vessel peripheral wall 26, or vice versa. The opening 50 includes at least one catch surface 52 and at least one ramped surface 58 formed by the frame 38, and the resiliently deflectable arm 54 includes at least one protrusion 60 defining a catch surface 56. The opening 50 can be provided by an aperture extending through the frame 38 and having a peripheral sidewall (as depicted), a recess (e.g., a notch or channel) formed in the frame, or by another type of opening in the frame. The resiliently deflectable arm 54 can be defined by an upper portion of the vessel peripheral wall 26 between two vertical slots in the peripheral wall, as depicted. One opening 50 and resiliently deflectable wall portion 54 are depicted, though more can be suitably provided.

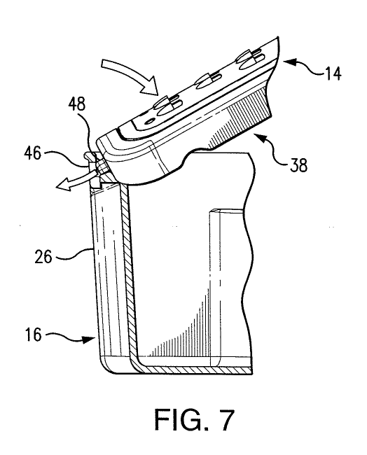

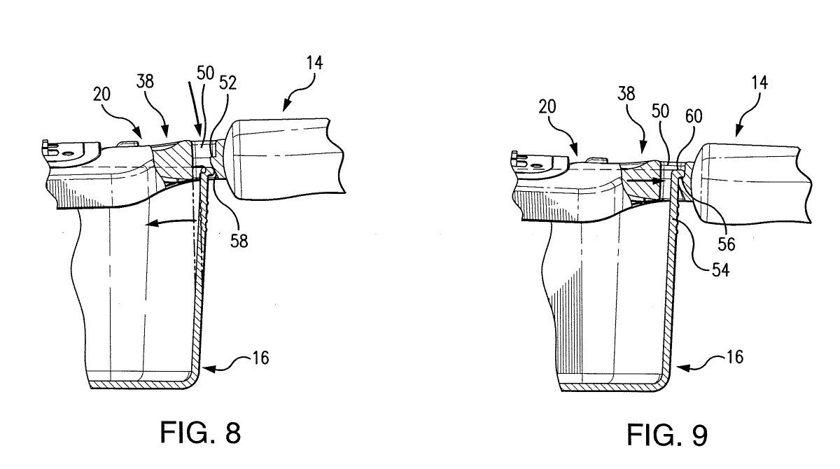

FIG. 7 shows the tab 48 being inserted into the slot 46 to mount the distal end of the grater 14 to the vessel 16, and FIGS. 8-9 show the proximal end of the grater 14 being mounted to the vessel 16. As the grater 14 is rotated down onto the vessel 16 (as indicated by the angular directional arrow of FIG. 8), the protrusion 60 slides against the ramped surface 58 to deflect the arm 54 (as indicated by the horizontal directional arrow of FIG. 8), as it slides into the opening 50. Then once the protrusion 60 clears the ramped surface 58, the arm 54 resiliently returns to its original position (as indicated by the horizontal directional arrow of FIG. 9), and now its catch surface 56 is engaged by and interferes with the catch surface 52 in the opening 50. To remove the grater, the resilient arm 54 is pushed in until the catch surfaces 52 and 56 are not in opposition, then the grater 14 is pivoted off the vessel 16. The resilient arm 54 can include a grip area 62 for the user to push on to disengage the catch surfaces 52 and 56 when removing the grater 14 from the vessel 16.

In use, this engagement of the distal interlocking elements (e.g., tab 48 and slot 46), and of the proximal interlocking elements (e.g., resilient arm catch surface 56 and opening catch surface 52), retain the grater 14 on the vessel 16. The user can then grasp the grater 14 by the handle 36, while it is mounted to the vessel 16 and the vessel is resting on a countertop or table, and slide a food item back and forth across the top surface of the grater panel-insert 22. The food item is thereby shaved into small pieces that fall through the apertures in the panel-insert 22 and into the container vessel 16 for containment. In this way, the vessel-grater interlocking elements provide for increased ease and safety of use.

In alternative embodiments, the mating interlocking elements on the vessel 16 and the grater 14 are provided by other coupling systems that are adapted to permit the grater 14 to be removably coupled to the vessel 16. Such alternative mating interlocking elements include other detent, snap-fit, and/or flanged closure systems such as those that function similarly to that depicted. In some such alternative embodiments, the resiliently deflectable arm extends through and out of the opening, includes an inwardly extending protrusion, and/or includes the ramped surface. In other such alternative embodiments, the tab and slot elements are at the proximal end and the opening and deflectable arm elements are at the distal end.

In addition, the vessel 16 includes at least one generally horizontal shelf 64 that extends inwardly (into the interior of the vessel) from the peripheral wall 26 and on which the grater 14 rests when it is mounted to the vessel. In this way, the grater 14 is more stable and less likely to move about during use to grate food items. In the embodiment depicted in FIGS. 1-2 and 6, for example, there are five shelves 64, with each formed by an inward recess in the peripheral wall 26. The recesses can be curved (such as the semi-circular recesses shown) so that the shelves 64 have curved inner edges, or they can be rectilinear or a combination thereof. The shelves 64 can extend inward a distance such that they support only the grater frame 38 (as depicted) or such that they support the grater frame and the insert-panel 22. It is noted that, due to the curved design of the frame 38 of the depicted embodiment, the shelf 64 at the distal end of the vessel is positioned at a greater elevation that the shelves 64 at the lateral sides.

In alternative embodiments, the container includes the shelves but no vessel-grater interlocking elements. In such embodiments, the grater rests on the shelves and is at least partially received within the vessel interior for stability, but it is not actually locked or secured to the container vessel.

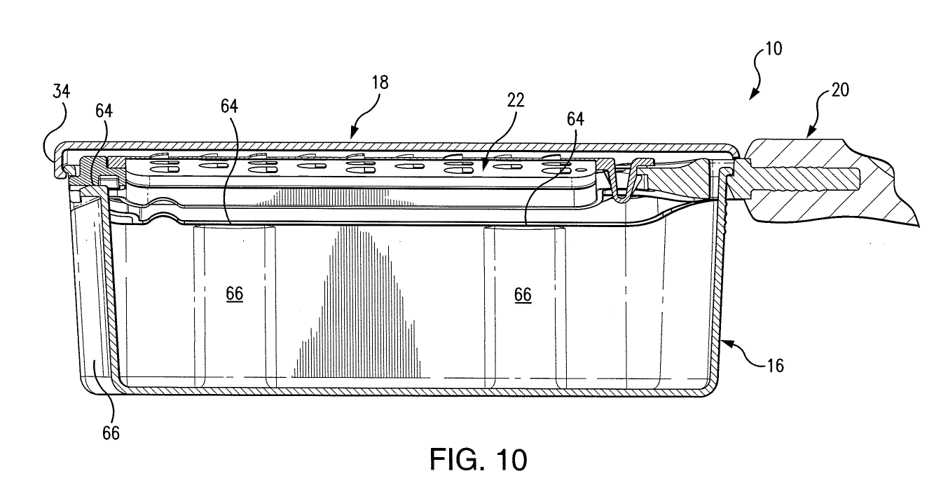

As shown in FIG. 10, the shelves 64 can be positioned a distance above the bottom wall 24 such that the grater 14 can be received in the vessel 16 when the lid 18 is mounted to the vessel. Thus, the container 12 can be stored by itself or together with the grater 14. The generally vertical wall section 34 of the lid 18 can be provided with a height sufficient to provide clearance in embodiments in which the grater 14 does not sit entirely within the vessel 16. This wall section 34 can also permit the lid to be slid down lower on the vessel 16 when the grater 14 is not first mounted to the vessel.

Referring to FIGS. 1-2 and 11-14, the insert-panel 22 is removably coupled to the peripheral frame 38 of the food grater 14 by a coupling system including mating interlocking elements on the insert-panel and on the grater frame. In the depicted embodiment, for example, there are two sets of panel-frame interlocking elements, one set each at the proximal and distal ends of the grater 14. The distal panel-frame interlocking element on the frame 38 can be provided by at least one slot 70 defined by the frame, and the one on the panel 22 can be provided by at least one tab 72 extending distally from the panel and receivable in the slot, or vice versa. Two slots 70 and tabs 72 are depicted, though more or fewer sets of these can be suitably provided.

The proximal panel-frame interlocking element on the frame 38 can be provided by at least one opening 74 in the frame, and the one on the panel 22 can be provided by at least one resiliently deflectable arm 76 extending proximally from the panel, or vice versa. The opening 74 includes at least one catch surface 78, and the resiliently deflectable arm 76 includes at least one protrusion 80 defining a catch surface 82 and at least one ramped surface 84. The resiliently deflectable arm 76 can be generally V-shaped with the ramped surface 84 defined on one of the two legs forming the V shape. The opening 74 can be provided by a recess (e.g., a notch or channel, as depicted) formed in the frame 38, an aperture extending through the frame and having a peripheral sidewall, or by another type of opening in the frame. One opening 74 and resiliently deflectable arm 76 are depicted, though more can be suitably provided.

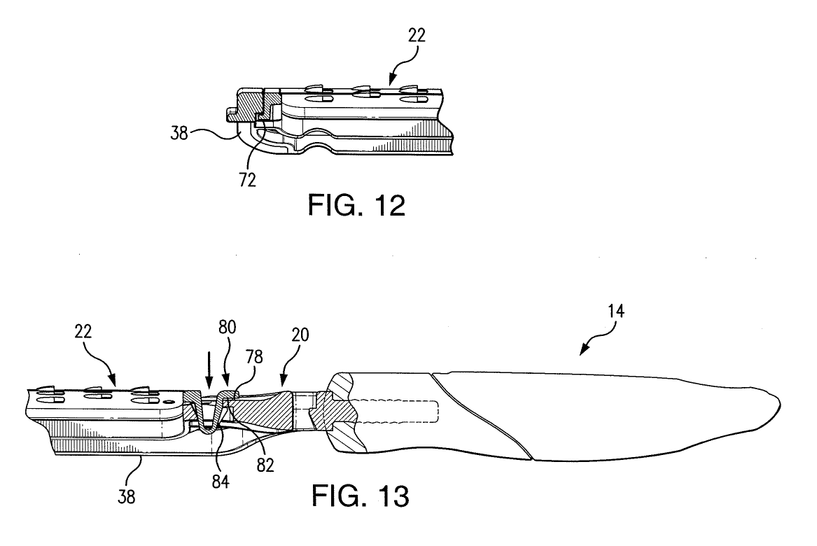

FIG. 12 shows the tabs 72 inserted into the slots 70 to mount the distal end of the insert-panel 22 to the frame 38. And FIG. 13 shows the proximal end of the insert-panel 22 mounted to the frame 38. As the insert-panel is rotated down onto the frame 38 with the tabs 72 and slots 70 engaged, a wall section of the frame 38 defining the opening 74 slides against the ramped surface 84 to deflect the arm 76 as it slides into the opening, thereby creating a biasing force that holds the arm in the opening. When the insert-panel 22 has been rotated all the way down onto the frame 38 to the use position, its arm catch surface 82 is engaged by and interferes with the catch surface 78 in the opening 74 to prevent farther downward movement and hold the panel in place.

To remove the insert-panel 22, the resilient arm 76 is pushed in and the insert-panel is pivoted off the frame 38. At that point, a second insert-panel 22a can be mounted to the frame 38 in the same way. The second insert-panel 22a is identical or at least similar to the first insert-panel 22, except that it has apertures with a different size, shape, and/or arrangement. For example, the second insert-panel 22a is designed for finer grating and the first insert-panel 22 is designed for coarser grating. Any number of additional insert-panels can be provided for interchangeably mounting to the frame 38 and providing different grating functions.

In alternative embodiments, the mating interlocking elements on the panel 22 and the frame 38 are provided by other coupling systems that are adapted to permit the panel to be removably coupled to the frame. Such alternative mating interlocking elements include other detent, snap-fit, and/or flanged closure systems such as those that function similarly to that depicted. In some such alternative embodiments, the tab and slot elements are at the proximal end and the opening and deflectable arm elements are at the distal end.

In the above-described embodiment, the food container 12 and the food grater 14 are packaged and sold together. In another embodiment, food container 12 and the food grater 14 are sold separately for use together. In yet another embodiment, a food grater without a replaceable insert-panel is provided for use with the food container 12. And in still another embodiment, a food grater 14 with a handle/frame assembly 20 and a replaceable grater insert-panel 22 is provided by itself, without regard to any possible use with the food container 12. In such embodiments, the food grater 14 can be provided with a plurality of the replaceable grater insert-panels 22 and 22a, with or with the container-engaging notch.

It is to be understood that this invention is not limited to the specific devices, methods, conditions, or parameters of the example embodiments described and/or shown herein, and that the terminology used herein is for the purpose of describing particular embodiments by way of example only. Thus, the terminology is intended to be broadly construed and is not intended to be unnecessarily limiting of the claimed invention. For example, as used in the specification including the appended claims, the singular forms “a,” “an,” and “the” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the claimed invention has been shown and described in example forms, it will be apparent to those skilled in the art that many modifications, additions, and deletions can be made therein without departing from the spirit and scope of the invention as defined by the following claims.

What is claimed is:

1. A food-grating system, comprising:
a food container including a vessel, a lid, and a closure system adapted to removably mount the lid to the vessel for storage whether or not the grater is also mounted to the vessel, wherein the vessel-lid closure system includes mating interlocking elements on the vessel and the lid; and
a food grater including a frame with a grater panel, a handle extending from the frame, and a grater-vessel coupling system adapted to removably mount the grater to the vessel for food-grating use whether or not the lid is also mounted to the vessel, wherein the grater-vessel coupling system includes mating interlocking elements on the vessel and the grater.

2. The food-grating system of claim 1, wherein the vessel includes a peripheral wall with an upper portion, the lid defines a periphery, and the vessel-lid interlocking elements are positioned at the vessel peripheral wall upper portion and the lid periphery.

3. The food-grating system of claim 2, wherein the vessel-lid interlocking elements are provided by a flange extending outward from the vessel peripheral wall upper portion and a flange extending inward from the lid periphery with an interference fit.

4. The food-grating system of claim 1, wherein the vessel and the grater each define a distal end and a proximal end, a first set of the grater-vessel interlocking elements are positioned at the distal end, and a second set of the grater-vessel interlocking elements are positioned at the proximal end.

5. The food-grating system of claim 4, wherein the first set of the grater-vessel interlocking elements are provided by a tab-and-slot arrangement and the second set of the grater-vessel interlocking elements are provided by a deflectable-arm-and-opening arrangement.

6. The food-grating system of claim 5, wherein the first set of the grater-vessel interlocking elements are provided by at least one tab extending from the grater frame and at least one slot formed in the vessel, and the second set of the grater-vessel interlocking elements are provided by at least one resiliently deflectable arm extending from the vessel and at least one opening formed in the grater frame.

7. The food-grating system of claim 1, wherein when the food grater is mounted to the vessel, at least a portion of the grater is positioned within the vessel.

8. The food-grating system of claim 1, wherein the vessel includes one or more generally horizontal interior shelves that extend inwardly from a peripheral wall thereof and upon which rests the grater frame when the grater is mounted to the vessel.

9. The food-grating system of claim 8, wherein the one or more shelves are formed by a generally semicircular recess formed in the vessel peripheral wall.

10. The food-grating system of claim 8, wherein the grater peripheral frame is curved and a first one of the shelves is positioned at a greater elevation that a second one of the shelves.

11. A food-grating system, comprising:
a food container including a vessel, a lid, and a closure system adapted to removably mount the lid to the vessel for storage whether or not the grater is also mounted to the vessel, wherein the vessel-lid closure system includes mating interlocking elements on the vessel and the lid; and
a food grater including a handle/frame assembly, a grater insert-panel, a grater-vessel coupling system adapted to removably mount the grater to the vessel for food-grating use whether or not the lid is also mounted to the vessel, and a frame-panel coupling system adapted to removably mount the insert-panel to the handle/frame assembly so that the insert-panel can be changed out for differing grating functions, wherein the grater-vessel coupling system includes mating interlocking elements on the vessel and the grater, the handle/frame assembly includes a peripheral frame and a handle extending therefrom, and the frame-panel coupling system includes mating interlocking elements on the frame and the insert-panel.

12. The food-grating system of claim 11, wherein the vessel includes a peripheral wall with an upper portion, the lid defines a periphery, and the vessel-lid interlocking elements are positioned at the vessel peripheral wall upper portion and the lid periphery.

13. The food-grating system of claim 11, wherein the vessel and the grater each define a distal end and a proximal end, a first set of the grater-vessel interlocking elements are positioned at the distal end, and a second set of the grater-vessel interlocking elements are positioned at the proximal end.

14. The food-grating system of claim 13, wherein the first set of the grater-vessel interlocking elements are provided by a tab-and-slot arrangement and the second set of the grater-vessel interlocking elements are provided by a deflectable-arm-and-opening arrangement.

15. The food-grating system of claim 11, wherein the frame and the panel each define a distal end and a proximal end, a first set of the frame-panel interlocking elements are positioned at the distal end, and a second set of the frame-panel interlocking elements are positioned at the proximal end.

16. The food-grating system of claim 15, wherein the first set of the panel-frame interlocking elements are provided by a tab-and-slot arrangement and the second set of the panel-frame interlocking elements are provided by a deflectable-arm-and-opening arrangement.

17. The food-grating system of claim 11, wherein the vessel includes one or more generally horizontal interior shelves that extend inwardly from a peripheral wall thereof and upon which rests the grater frame when the grater is mounted to the vessel.

18. A food-grating system, comprising:
a handle/frame assembly including a peripheral frame and a handle extending therefrom;
a first grater insert-panel defining a first array of apertures and first adjacent blades;
a second grater insert-panel defining a second array of apertures and second adjacent blades; and
a frame-panel coupling system adapted to interchangeably mount the first and second insert-panels to the frame so that the insert-panels can be changed out for different grating functions, wherein the frame-panel coupling system includes mating interlocking elements on the frame and the insert-panel.

19. The food-grating system of claim 18, wherein:
the frame and the panel each define a distal end and a proximal end, a first set of the frame-panel interlocking elements are positioned at the distal end, and a second set of the frame-panel interlocking elements are positioned at the proximal end,
the first set of the panel-frame interlocking elements are provided by a tab-and-slot arrangement, and the second set of the panel-frame interlocking elements are provided by a deflectable-arm-and-opening arrangement, and
the first set of the panel-frame interlocking elements are provided by at least one tab extending from the insert-panel and at least one slot formed in the grater frame, and the second set of the panel-frame interlocking elements are provided by at least one resiliently deflectable arm extending from the insert-panel and at least one opening formed in the grater frame.

20. The food-grating system of claim 18, wherein the food-grating system is adapted for use with a kitchen structure having a generally vertical wall with an upper end, wherein the grater frame includes at least one lateral notch positioned so that it catches on the wall upper end to help hold the grater in place during grating use.
